(19) United States
(12) Patent Application Publication
(10) Pub. No.: US 2005/0004878 A1
(43) Pub. Date: Jan. 6, 2005

(54) Methods for enabling a user to send a customized gift package to a recipient

(76) Inventor: Larry Malone, Eads, TN (US)

Correspondence Address: DINSMORE & SHOHL, LLP, 1900 CHEMED CENTER, 255 EAST FIFTH STREET, CINCINNATI, OH, 45202, US

(21) Appl. No.: 10/613,287

(22) Filed: Jul. 3, 2003

(51) Int. Cl. G06F 17/60

(52) U.S. Cl. 705/400

(57) ABSTRACT

A method of business for sending a customized gift package to a recipient comprises offering a plurality of customized gift package options to a user and receiving a selected gift package option from a user, offering a plurality of gift options to a user and receiving a selected gift option from a user, and transferring the information corresponding to the selected gift package option and the selected gift option to at least one point of distribution for assembly and shipping of a customized gift package comprising the selected gift package option and the selected gift option.

### TECHNICAL FIELD

The present invention relates generally to customized gifts and methods for sending a customized gift package, and more specifically to a unique method for designing, personalizing and sending a customized gift package to a recipient.

### BACKGROUND OF THE INVENTION

The information revolution and particularly the Internet, has had a great effect on commerce. One area of e-commerce that can utilize these technological advances is the customized gift market. While various corporate incentive gift companies exist, the amount of customization and personalization of the gift package is often limited. For example, many custom incentive gift companies limit customization to choosing a style of gift card or gift wrap and a message included on the gift card. In addition, the time and costs in order to generate the customized package with a personalized custom logo or image can be quite excessive and make the operation cost and time prohibitive.

For example, typically a user would be required to send the graphic file containing the custom logo or image to a printing company or graphic artist to be personalized and printed. This printing will then need to be sent to the company assembling the customized gift. The customized container may need to be specially ordered to obtain the custom color combinations. Once the customized container has been generated, it needs to be sent to the company assembling the customized gift. Once the custom logo or image print-out and customized container have arrived at the point of assembly, the customized package with custom logo or image can finally be assembled and shipped to a recipient. This process would typically be repeated for each recipient.

Consumers typically have limited control in the gift package and the corporate incentive gift market. Manufacturers of these products typically have predetermined packaging options and do not allow a consumer to easily personalize or customize the package options to his needs and desires. This inability to easily personalize or customize packaging often leads to less effective corporate incentive gift packages.

When delivering a perishable food item as a gift, it is important that the gift item arrive in a manner that optimizes freshness and minimizes any spoilage of the perishable food. However, often the predetermined shipping method corresponding to the selected gift can lead to excessive shipping costs and a less expensive option could have been selected but quality and freshness of the product maintained. The weather conditions, specifically, the temperature can greatly affect the overall quality and desirability of the gift item. For example, if the recipient lives in a traditionally mild temperature climate, but the area is currently experiencing record high temperatures, the method of shipping the item may not account for the high temperatures. Similarly, the recipient may live in a traditionally elevated temperature area, but may be experiencing a mild weather pattern, the user may be able to send the customized gift by a less costly shipping method that will still preserve the freshness and quality of the customized gift item.

With the increased use of e-commerce, there is need to provide methods for purchasing and sending a personalized, customized gift package to a recipient.

### SUMMARY OF THE INVENTION

The present invention is directed to methods for enabling a user to send a personalized and/or customized gift package to a recipient. The methods allow a user to select a gift package option as well as a gift option and to have the customized gift packaged sent to a recipient's location.

One embodiment of the present invention is a method for enabling a user to send a personalized, customized gift package to a recipient. The method comprises offering a plurality of customized gift package options to a user; receiving a selected gift package option from a user; offering a plurality of gift options to a user; receiving a selected gift option from a user; and transmitting information corresponding to the selected gift package option and the selected gift option to at least one point of distribution for assembly and shipping of a customized gift package comprising the selected gift package option and the selected gift option. Offering the plurality of customized gift package options includes offering a plurality of art options and the plurality of art options includes offering to receive a graphic file from a user.

Another embodiment of the present invention is a method for enabling a user to send a customized gift package to a recipient. The method comprises: offering a plurality of customized gift package options to a user; receiving a selected gift package option from a user; offering a plurality of gift options to a user; receiving a selected gift option from a user; receiving a shipping destination from a user; determining one or more shipping methods based on the shipping destination and the selected gift option; offering the determined shipping methods to a user; receiving a selected shipping option from a user; and transmitting information corresponding to the selected gift package options, the selected gift option, and the selected shipping option to a point of distribution for assembly and distribution of a customized gift package comprising the selected gift package option and the selected gift option. Determining one or more shipping methods based on the shipping destination and the selected gift option comprises comparing a forecasted high temperature for the shipping destination with a plurality of shipping methods wherein each shipping method comprises a recommended maximum temperature and offering to a user a list of shipping methods in which the recommended maximum temperature is greater than or equal to the forecasted high temperature data; and receiving a selected shipping method from a user.

Another embodiment of the present invention is a network-based method for providing a personalized, customized gift package to a recipient. The method comprises providing a website having a user interface; displaying through the user interface a plurality of customized gift package options to a user; receiving at the user interface a selected gift package option from a user; displaying through the user interface a plurality of gift options; receiving at the user interface a selected gift option from a user; transmitting information corresponding to the selected gift package option and the selected gift option to at least one point of distribution for assembly and shipping of a customized gift package comprising the selected gift package option and the selected gift option. Offering the plurality of customized gift package options includes offering a plurality of art options and the plurality of art options includes offering to receive a graphic file from a user.

Another embodiment of the present invention is the network-based method for providing a customized gift package to a recipient. The method comprises the act of: providing a website having a user interface; displaying through the user interface a plurality of customized gift package options; receiving at a user interface a selected gift package option from a user; displaying through the user interface a plurality of gift options to a user; receiving at the user interface a selected gift option from a user; receiving at the user interface a shipping destination; determining one or more shipping methods based on the shipping destination and the selected gift option; displaying through the user interface one or more shipping methods to a user; receiving at the user interface a selected shipping option from a user; and transmitting information corresponding to the selected gift package option, the selected gift option, and the selected shipping option at least one a point of distribution for assembly and shipping of a customized gift package comprising the selected gift package option and the selected gift option. Determining one or more shipping options based on the shipping distinction and the selected gift option comprises comparing a forecasted high temperature for the shipping destination with a plurality of shipping methods and offering to the user a list of shipping methods in which the recommended maximum temperature is greater than or equal to the forecasted high temperature.

Another embodiment of the present invention is a computer data signal embodied in a carrier wave and representing sequences of instructions which, when executed by a processor, provide a customized gift package to a recipient, by performing the following: offering a plurality of customized gift package options to a user; receiving a selected gift package option from a user; offering a plurality of gift options to a user; receiving a selected gift option from a user; and transmitting information corresponding to the selected gift package option and the selected gift option to at least one point of distribution for assembly and shipping of a customized gift packaging comprising the selected gift package option and the selected gift option. The act of offering the plurality of gift package options includes offering a plurality of art options and the plurality of art options includes offering to receive a graphic file from a user.

Another embodiment of the present invention is a computer data signal embodied in a carrier wave and representing sequences of instructions which, when executed by a processor, provide a customized gift package to a recipient, by performing the following: offering a plurality of customized gift package options to a user; receiving a selected gift package option from a user; offering a plurality of gift options to a user; receiving a selected gift option from a user; and receiving a shipping destination from a user; determining one or more shipping methods based on the shipping destination and the selected gift option; offering the determined shipping methods to a user; receiving a selected shipping option from a user; and transmitting information corresponding to the selected gift package option, selected gift option, and the selected shipping option to at least one point of distribution for assembly and distribution of a customized gift package comprising the selected gift package option and the selected gift option. Determining one or more shipping options based on the shipping destination and the selected gift option comprises comparing a forecasted high temperature for the shipping destination with a plurality of shipping methods wherein each shipping method comprises a recommended maximum temperature for shipping the selected gift options and offering to the user a list of shipping methods in which the recommended maximum temperature is greater than or equal to the forecasted high temperature.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a flow diagram of an exemplary method according to an embodiment of the present invention; and

FIG. 2 is a flow diagram of an exemplary method according to another embodiment of the present invention;

FIG. 3 is schematic illustration of an exemplary client/server embodiment of the present invention;

FIG. 4 is a flow diagram of an exemplary network-based method according to an embodiment of the present invention;

FIG. 5 is an illustration of an exemplary user interface according to an embodiment of the present invention;

FIG. 6 is an illustration of an exemplary user interface according to an embodiment of the present invention;

FIG. 7 is an illustration of an exemplary user interface according to an embodiment of the present invention;

FIG. 8 is an illustration of an exemplary user interface according to an embodiment of the present invention;

FIG. 9 is an illustration of an exemplary user interface according to an embodiment of the present invention; and

FIG. 10 is an illustration of an exemplary user interface according to an embodiment of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION

Reference will now be made in detail to various embodiments of the invention, examples of which are illustrated in the accompanying drawings, wherein like numerals indicate similar elements throughout the views.

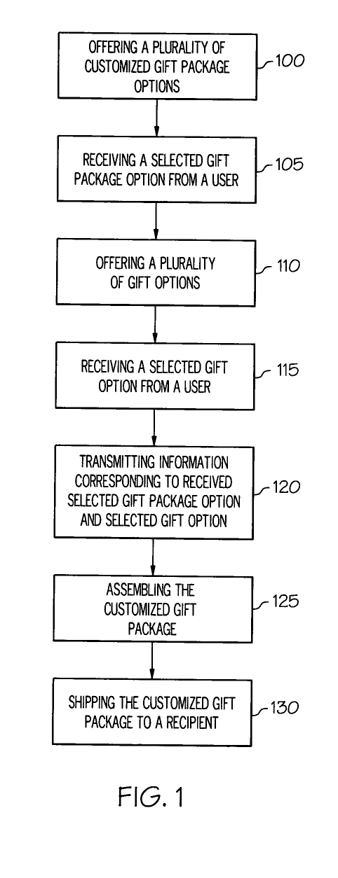

FIG. 1 illustrates an exemplary method for sending a personalized and/or customized gift package to a recipient, wherein steps of the method are illustrated as steps in the flow diagram. The method comprises offering a plurality of customized gift package options (100) to a user. The user may review the plurality of gift packaging options and selects a gift package option from the list. The selected gift package option is received from the user (105). The method also comprises offering a plurality of gift options to be placed in the selected gift package (110). The user selects a gift option from the list provided. The selected gift option of the user is received (115). While the flow diagrams show the gift package option selection is received prior to the gift option selection, it is equally within the illustrated methods and invention that the gift option selection may be received prior to the gift package option selection. Information is transmitted corresponding to the received selected gift package option and the received selected gift option to at least one point of distribution for assembly and shipping of a customized gift package (120). The assembly and shipping may be conducted at a single point of distribution or at respective points of distribution or at multiple combined points of distribution, or at any combination thereof. The customized gift package comprises the selected gift package option and the selected gift option. In one embodiment of the present invention, the act of offering the plurality of customized gift package options to a user (100) includes offering to receive a graphic file from a user. In a further embodiment, the plurality of art options are capable of being customized with the recipient's name, a user's name, or both.

Exemplary gift package options include, but are not limited to: choosing a graphical design for each gift occasion; personalizing the graphical design with the recipient's name, the sender's name and/or a logo; adding a logo or photo to the graphical design; and selecting a color scheme of the package container. In one embodiment of the present invention, the user can choose from a plurality of graphical designs sorted by gift occasion. In another embodiment of the present invention, the user can choose their own original graphic design to be included on the personalized package. For example, the user can send (by email, internet, FTP, mail, etc.) a photo or graphic to be utilized in the gift package.

In a further embodiment, the method optionally further comprises assembling the customized gift package (125) corresponding to the selected gift package option and the selected gift option, and optionally shipping the customized gift package is then shipped to a recipient (130) at a shipping destination.

The plurality of personalized and/or customized gift package options may comprise offering a plurality of container color combinations to a user and receiving a selected container color combination from a user. In addition, the method may comprise requesting a personalized message to a recipient from a user and receiving the personalized message from the user. These methods then may further comprise transmitting information corresponding to the selected color combination and/or the received personalized message from the user to the point of distribution for assembly and shipping. The personalized message may then be included with the customized gift package to the recipient.

In one exemplary embodiment, the personalized and customized gift package comprises a keepsake box. Each box will feature an original graphic design customized to the specifications of the user. The user may select the graphic design from an online library of graphic designs. In addition, a personal message can be included on the inside of the box. The lid and bottom of the box can be mixed and matched to create hundreds of color combinations. This can allow an individual to select a color scheme which identifies their organization, corporation etc. In one embodiment, hundreds of color combinations for the bottom of the box and lid can be selected by PMS (Pantone® Matching System) values. The graphic design can be personalized by receiving a logo or text from the user and creating a transparent background image for the logo or text received from the user. The image with a transparent background is then blended into the selected graphic design.

In another embodiment of the present invention, the customized gift package options further comprise inclusion of materials in addition to the selected gift option, such as marketing materials or other items from the user. For example, a recording artist sending a customized gift package to one or more fans may include a recording such as a compact disc (CD) of their music, a photo, or other memorabilia. Other exemplary materials that can be included in the customized gift package include: documents, photos, toys, promotional items, etc.

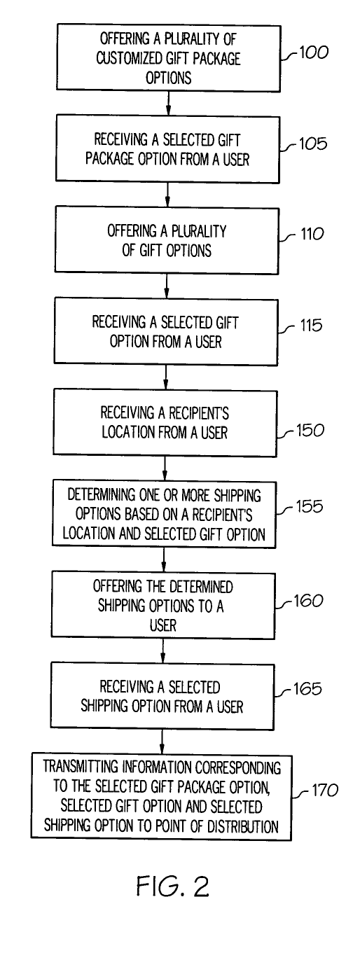

Another embodiment of the present invention is depicted in the flowchart of FIG. 2. FIG. 2 depicts the method for sending a customized gift package to a recipient according to the present invention. A plurality of customized gift package options are offered to a user (100). The user selects a gift package option from the plurality of gift package options offered to the user. The selected gift package option is received from the user (105). A user is also offered a plurality of gift options (110). The selected gift option is received from the user (115). Exemplary gift options may comprise perishable food items, non-perishable food items, and other gifts. For example, perishable food items may include ham or other meats, desserts such as cakes, pies, cheesecakes, and the like, or combinations of all. The user is requested to input a shipping destination, for example, a recipient's location. The recipient's location is received from the user (150). One or more shipping options is determined based on the recipient's location and selected gift option (155). The determined shipping options are offered to the user (160) and a selected shipping option is received.

For example, the user may be presented multiple shipping options based on selected gift option, the recipient's location and the like. A selected shipping option is received from the user (165) from the shipping options that were offered to the user. Information corresponding to the selected gift package option, the selected gift option and the selected shipping option are transmitted to the point of distribution for assembly and shipping of a customized gift package comprising the selected gift package and the selected gift option. In a further embodiment, the method further comprises optionally assembling the customized gift package and optionally shipping the customized gift package to a recipient according to the selected shipping option.

In one embodiment, the determining one or more shipping options is based on the recipient's location and the selected gift option, together with relevant weather information. For example, in one embodiment, the method comprises comparing a forecasted high temperature for the recipient's location with one or more shipping methods, wherein each shipping method comprises a recommended maximum temperature for shipping the selected gift option and offering to the user a list of shipping methods in which the recommended maximum temperature is greater than or equal to the forecasted high temperature. In a further embodiment, current forecasted high temperature data corresponding to the recipient's location may be retrieved from an online weather service. In addition, a predetermined number of days of forecasted high temperature data may be retrieved to insure that the shipping option will still insure a quality, consistent product is delivered.

Often computers telecommunicate with each other and share information, applications and/or services. Sometimes in this setting, the various computers are referred to as nodes, which is a generic term referring to a point in an interconnected system. One type of computer network employs a client/server architecture, wherein the portions of network applications that interact with human users are typically separated from the portions of network applications that process requests and information. Often, the portions of an application that interact with users and access network resources are called client applications or client software and portions of an application that process requests and information are called server applications or server software. Client machines tend to run client software and server machines tend to run server software, however, a server can be a “client” as well. In one embodiment of the present invention, a user interface is typically provided on a client machine (which might be any of the user interface alternatives contemplated and exemplified below, such as a network computer, stand alone computer, interactive kiosk, etc.) and the software containing the computer instructions which comprise the methods according to the present invention may be located on a server computer, separate from the client machine.

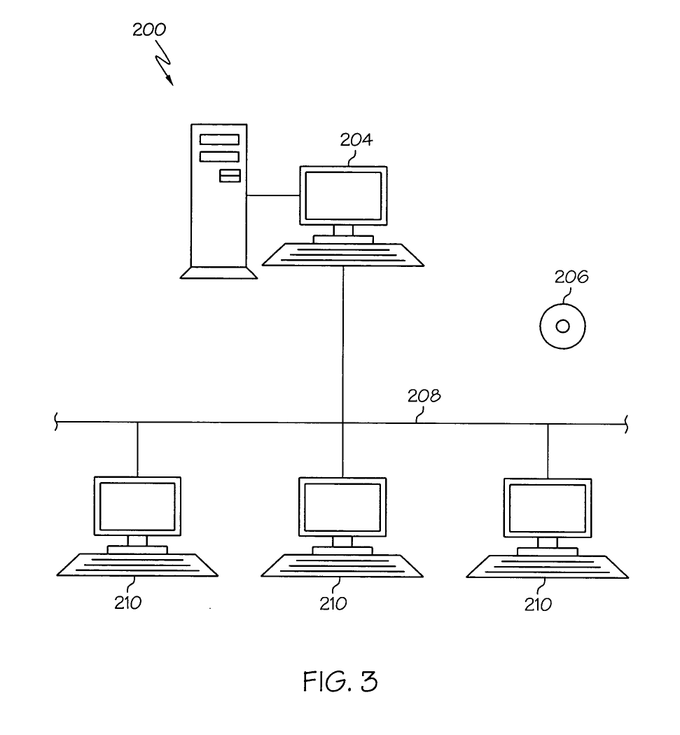

FIG. 3 schematically illustrates an exemplary client/server network 200 which might be employed to implement an embodiment of the present invention. As one with ordinary skill in the art would readily appreciate, a client/server network is only one type of network, and a variety of other configurations, such as peer-to-peer connections, are also considered networks. In a client/server network, a plurality of nodes are interconnected such that the various nodes send and/or receive information to/from one another. As shown here, a server node 204 is interconnected with a plurality of client nodes 210 using a connection 208 such as token ring, Ethernet, telephone modem connection, radio or microwave connection, parallel cable, serial cables, telephone lines, universal serial bus “USB”, firewire, blue-tooth, fiber optics, infrared “IR”, radio frequency “RF”, and the like, or combinations thereof.

A computer-readable medium, shown as a CD-ROM 206 holds information readable by a computer such as programs, data, files, etc. As will be readily appreciated, computer-readable medium can take a variety forms, including magnetic storage (such as hard disk drives, floppy diskettes, etc.), optical storage (such as laser disks, compact disks, DVD's, etc.), electronic storage (such as random access memory “RAM”, read-only memory “ROM”, programmable readable-only memory “PROM”, etc.), and the like.

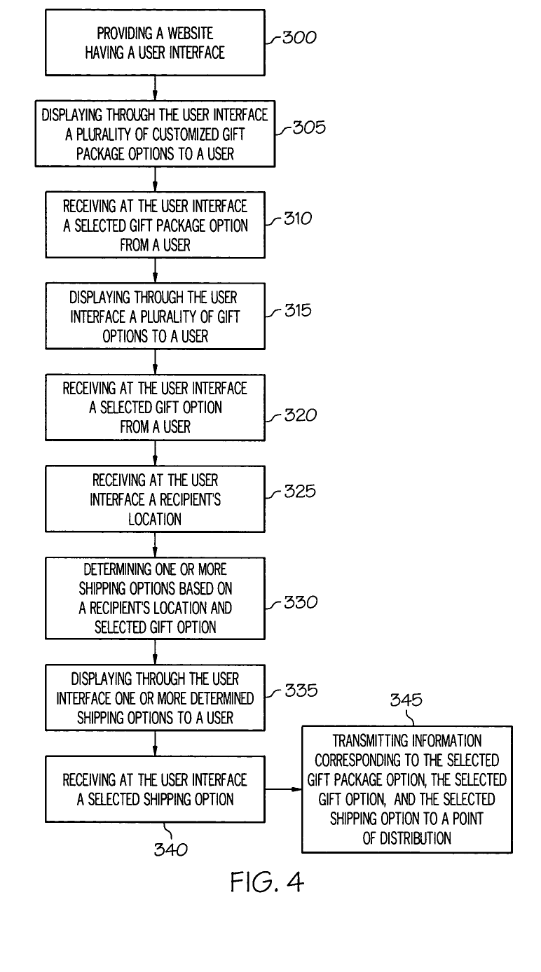

Yet another embodiment of the present invention comprises a network-based method for providing a personalized and/or customized gift package to a recipient and is depicted in FIG. 4. The network based method comprises providing a website having a user interface (300). A plurality of customized gift package options are displayed through the user interface to a user (305). The user selects a customized gift package option from the plurality of customized gift package options presented on the user interface. The selected gift package option is received at the user interface from the user (310). A plurality of gift options are also displayed through the user interface to the user (315). Once the user selects a gift option, the selected gift option is received at the user interface from the user (320). Information corresponding to the selected gift package option and the selected gift option is transmitted to at least one point of distribution for assembly and shipping of the customized gift package (345).

In one embodiment, the method further comprises receiving at the user interface a shipping destination such as a recipient's location (325). For example, the user may enter the recipient's name and shipping address for the customized gift package. The recipient's location is received at the user interface (325). Utilizing the recipient's location and the selected gift option, one or more shipping options can be determined (330). This determination may comprise comparing a forecasted high temperature for recipient's location with a plurality of shipping methods, wherein each shipping method comprises a recommended maximum temperature for the selected gift option and displaying to the user a list of shipping methods in which the recommended maximum temperature is greater than or equal to the forecasted high temperature. In one embodiment, current forecasted high temperature data is retrieved from a on-line weather service for the recipient's location for a predetermined number of days, wherein the predetermined number of days is equal to the number of days of shipping. The determined shipping options are then displayed through the user interface to the user (335). The user, after reviewing the displayed shipping options, selects a shipping option and this selection is received at the user interface (340). The selected shipping option is also transmitted to the point of distribution (345). In a further embodiment, the customized gift package is assembled and shipped to the recipient by the selected shipping option.

In one embodiment, the website is hosted on a network such as a wide-area network, local-area network, or the Internet, and the like. The Internet and the worldwide web operate on the client/server model and the user runs a web client, or browser, on an electronic device such as a computer, PDA, cell phone, telephone, TV tuner, or the like. The web browser contacts a web server and requests data information, in the form of a uniform resource locator (URL). This data information comprises the user interface of the present invention. Typically, URL addresses are typed in the browser to access web pages, and URL addresses are embedded within the pages themselves to provide hypertext links to other pages. A hypertext link allows the user to click on the link and be redirected to the corresponding website to the URL address of the hypertext link. Many browsers exist for accessing the worldwide web, such as Netscape Navigator™ and Internet Explorer™ from Microsoft Corp. Similarly, numerous web servers exist for providing content to the worldwide web, such as Apache™ from the Apache Group, Internet Information Server™ from Microsoft Corp., Lotus Domino™ Server from IBM, Netscape Enterprise Server™ from Netscape Communications Corp. and Oracle™ Application Server from Oracle Corp. These browsers and web servers can be utilized to allow access to the present invention from virtually any web-accessible device.

The user interface of the present invention may comprise a kiosk, a computer, a personal digital assistant (PDA), a device with wireless application programs (WAP) such as cell phone, auto-computer, or PDA, interactive TV, or an Internet appliance, or the like. The user interface allows the user to communicate and interact with the method of the present invention, and as will be understood, can take any of a virtually unlimited number of forms. For example, the user interface may comprise a computer system comprising a computer processing unit (CPU), memory, a visual display device and an input means. Exemplary input means may comprise a keyboard or mouse or other means of input such as speech recognition and/or visual input. Another embodiment of the present invention comprises a computer-readable storage medium comprising executable code for executing a computer to perform the method of the present invention.

In one exemplary embodiment of the present invention, a user may create a customized gift package at a kiosk. The kiosk offers the user a plurality of customized gift package options. The user makes a selection of one of the options and the kiosk receives the selected gift package option from the user. The user is then offered a plurality of gift options. The user makes a selection of one of the options and the kiosk receives the selected gift option. Information corresponding to the selected gift package option and the selected gift option is transmitted to at least one point of distribution for assembly of a customized gift package comprising the selected gift package option and the selected gift option. The plurality of customized gift package options include a plurality of art options to personalize the gift package. One of the art options includes receiving a graphic file from a user. After the customized gift package is assembled, the package can be presented to the user allowing the user to directly deliver the customized gift package to the recipient at a later time. In another embodiment, the customized gift package is shipped to the recipient after assembly.

Another embodiment of the present invention is a computer data signal embodied in a carrier wave and representing sequences of instructions which, when executed by a processor, provide a customized gift package to a recipient, by performing the following: offering a plurality of customized gift package options to a user; receiving a selected gift package option from a user; offering a plurality of gift options to a user; receiving a selected gift option from a user; receiving a shipping destination from a user; determining one or more shipping methods based on the shipping destination and the selected gift option; offering the determined shipping methods to a user; receiving a selected shipping option from a user; and transmitting information corresponding to the selected gift package option, the selected gift option and the selected shipping option to at least one point of distribution for assembly and distribution of the customized gift package comprising the selected gift package option and the selected gift option. In one embodiment, determining one or more shipping options based on the recipient's location and the selected gift option comprises comparing a forecasted high temperature for recipient's location with one or more shipping methods, wherein the shipping methods comprise a recommended maximum temperature for shipping the selected gift option and offering to the user a list of shipping methods in which the recommended maximum temperature is greater than or equal to the forecasted high temperature.

### EXAMPLE

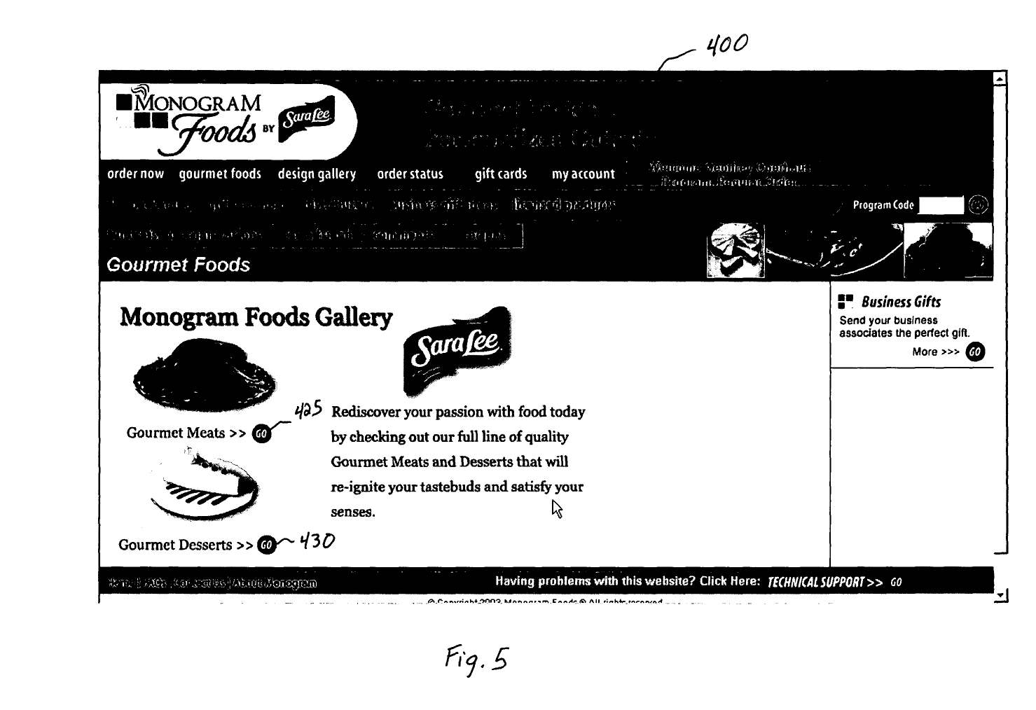

The following example depicts a typical scenario of a user selecting and sending a personalized and customized gift package to a recipient according to the method and system of the present invention. FIG. 5 depicts an exemplary selection and personalization of a gift package by a fictional user “Bill” of “The Montgomery Group” to be sent to a fictional recipient “Stan” of “ESP Marketing”. As depicted in FIG. 5, the user interface 400 begins the interaction by welcoming the user to the online system for selection and customization/personalization of a gift package.

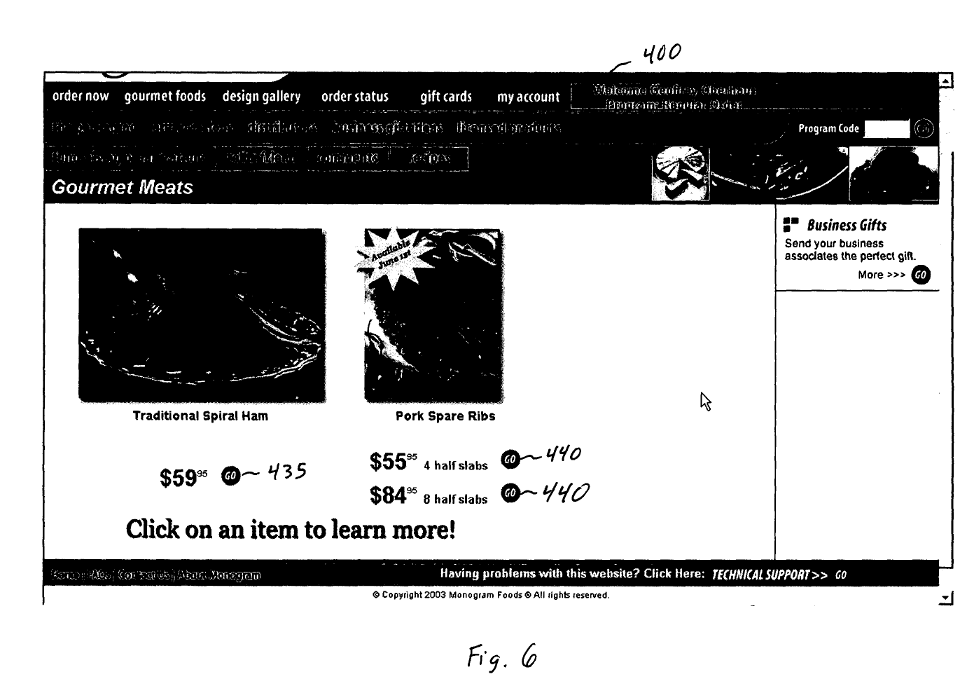

The system is running on a standard computer web server. The web server is connected to the Internet. Bill is using an ordinary home or office computer comprising a CPU and memory. The web server sends instructions to the user interface 400 to display a plurality of customized gift options to a user. The user interface (i.e., web browser) 400 on Bill's computer displays the plurality of customized gift options. In this exemplary embodiment, the gift options include Gourmet Meats 425 and Gourmet Desserts 430. Bill decides that he wants to send Stan something in the Gourmet Meats 425 category. Bill selects/clicks on the Gourmet Meats button 425. The user interface 400 sends data corresponding to the selection of Gourmet Meats 425 to the web server. The web server then sends instructions to the user interface 400 to display a plurality of Gourmet Meats available for selection. The user interface 400 then displays (FIG. 6) on Bill's computer the corresponding plurality of Gourmet Meats available to be sent to Bill.

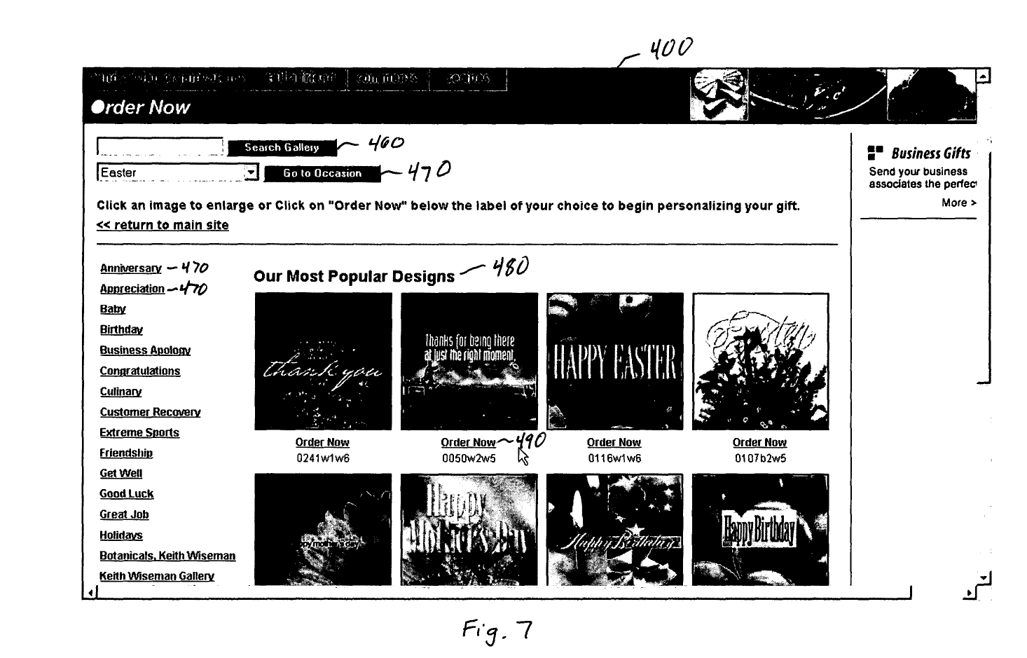

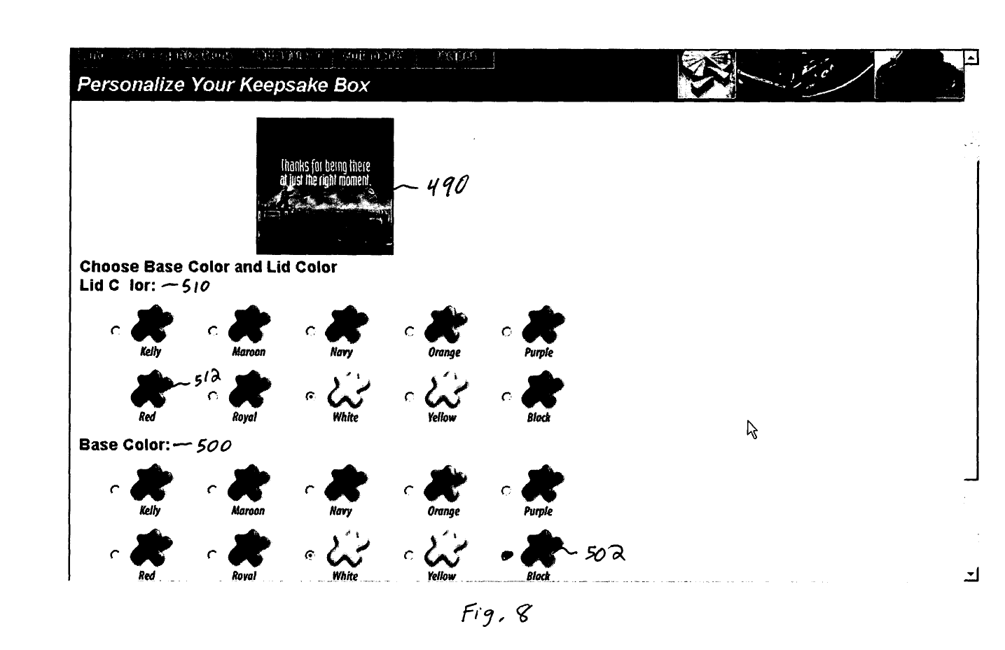

In this example, the plurality of Gourmet Meats options comprise a traditional spiral ham 435 and Pork Spare Ribs 440. Bill decides that he wants to send Stan the traditional spiral ham. Bill clicks on the traditional spiral ham button 435 and the user interface 400 sends data corresponding to the selection to the web server. The web server then sends instructions to the user interface 400 to display a plurality of graphic design options available for selection. The user interface having received the instructions, displays (FIG. 7) on Bill's computer a plurality of graphic design options. The user interface allows Bill to search 460 the graphic design gallery, select an occasion 470 or choose one of the most popular designs 480. Bill selects the graphic design 490 that is to be placed on the lid of the customized gift package containing the traditional spiral ham being sent to Stan. The user interface 400 sends data corresponding to the selected graphic design 490 to the web server. The web server then sends instructions to the user interface 400 to display a plurality of options to personalize the customized package (i.e., keepsake box). The user interface 400 then displays (FIG. 8) on Bill's computer the plurality of personalization options which include choice of the package base color 500 and package lid color 510.

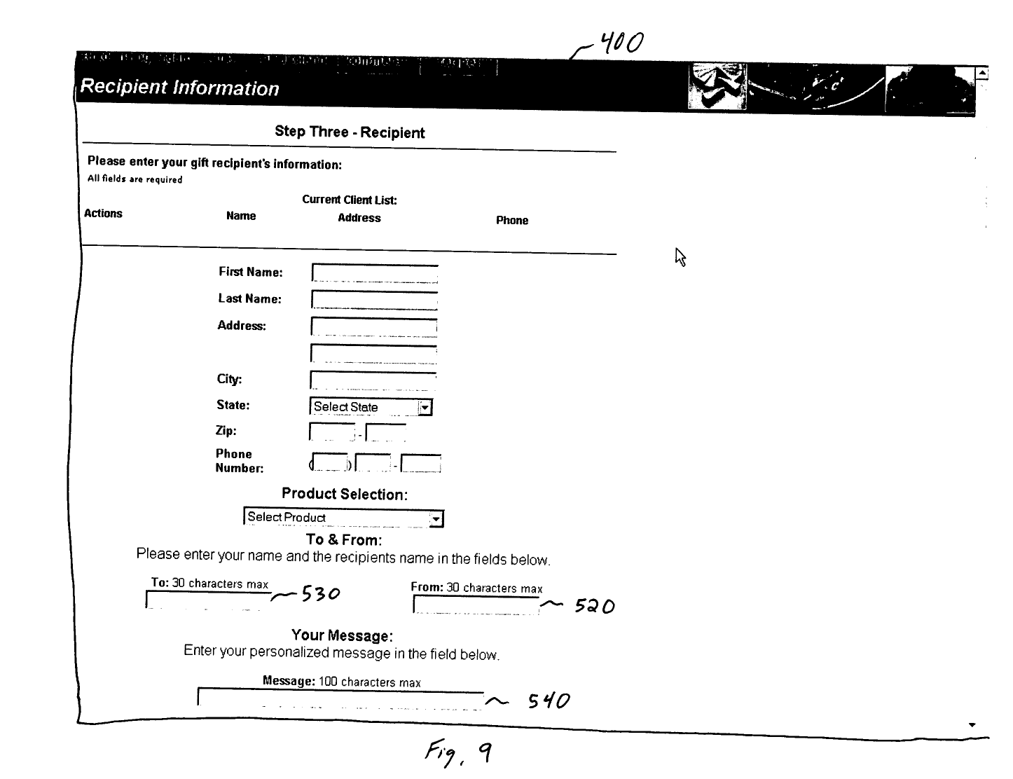

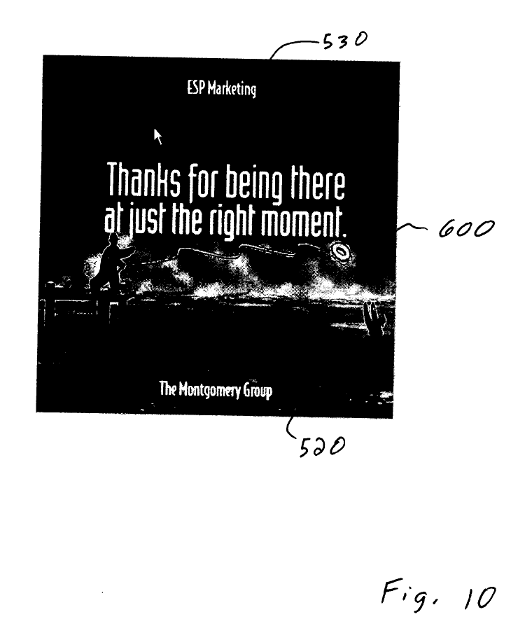

Bill selects a Red lid 512 and a black base 502 which corresponds to his organization, The Montgomery Group, color scheme. The user interface 400 transmits data corresponding to the package color selections to the web server. The web server then transmits instructions to the user interface 400 to display (FIG. 9) additional personalization options. The user interface 400 displays on Bill's computer, additional personalization options corresponding to the transmitted instructions from the web server. The personalization options include: the sender's name 520, the recipient's name 530 and a personalized message 540 to be included in the gift package. Bill enters his organization's name “The Montgomery Group” and Stan's company name “ESP Marketing” in the corresponding entry windows and then enters a personal message to Stan in the message window. The user interface 400 transmits data corresponding to the inputted data to the web server. The web server then sends instructions to the user interface 400 to confirm the order and obtain delivery and payment instructions. The web server also transmits to at least one point of distribution the data corresponding to all of the selections and input received from Bill. The selected graphic design 490 is personalized (FIG. 10) by blending the sender's name 520 and recipient's name 530 onto the graphic design 600. If Bill had sent a logo with his order, the logo would also be transparently blended into the selected graphic design. At the point of distribution, the personalized graphic design and message are printed on a high-quality, high-volume graphic printer. The customized package is then assembled and includes the traditional spiral ham, insulation materials if needed, the personal message from Bill to Stan, and the keepsake box in a color scheme matching Bill's organization. The personalized gift and package is then shipped to Stan by a selected shipping method.

The foregoing description of the various embodiments of the invention has been presented for the purposes of illustration and description. It is not intended to be exhaustive or limit the invention to the precise form disclosed. Many alternatives, modifications and variations will be apparent to those skilled in the art of the above teaching. Accordingly, this invention is intended to embrace all alternatives, modifications and variations that have been discussed herein, and others that fall within the spirit and broad scope of the claims.

1. A method for enabling a user to send a customized gift package to a recipient, comprising:
offering a plurality of customized gift package options to a user;
receiving a selected gift package option from a user;
offering a plurality of gift options to a user;
receiving a selected gift option from a user; and
transmitting information corresponding to the selected gift package option and the selected gift option to at least one point of distribution for assembly and shipping of a customized gift package comprising the selected gift package option and the selected gift option;
wherein offering the plurality of customized gift package options includes offering a plurality of art options and further wherein the plurality of art options includes offering to receive a graphic file from a user.

2. The method of claim 1, wherein the plurality of art options can be customized with a recipient's name, a user's name, a logo, or any combination thereof.

3. The method of claim 1, further comprising:
receiving a shipping destination from a user;
determining shipping methods based on the shipping destination and the selected gift option;
offering the determined shipping methods to a user;
receiving a selected shipping option from a user; and
transmitting information corresponding to the selected shipping option to the point of distribution.

4. The method of claim 3, wherein determining shipping methods further comprises:
accessing a weather forecasting database;
retrieving forecasted high temperature data corresponding to the shipping destination for a predetermined number of days;
comparing the retrieved forecasted high temperature data with a plurality of shipping methods, wherein each shipping method comprises a recommended maximum temperature for the selected gift option;
offering to the user a list of shipping methods in which the recommended maximum temperature is greater than or equal to the forecasted high temperature data; and
receiving a selected shipping option from the user.

5. The method of claim 1, further comprising:
assembling the customized gift package; and
shipping the customized gift package to the shipping destination.

6. The method of claim 5, further comprising:
requesting a personalized gift message from a user;
receiving the personalized gift message from the user;
transmitting information corresponding to the received personalized gift message to the point of distribution; and
generating a message card; wherein the message card comprises the received personalized gift message, and
including the message card with the customized gift package prior to shipping.

7. The method of claim 1, wherein offering a plurality of customized gift package options further comprises:
offering a plurality of container color combinations to a user; and
receiving a selected container color combination from a user.

8. The method of claim 1, further comprising:
requesting a personalized gift message from a user;
receiving the personalized gift message from the user; and
transmitting information corresponding to the received personalized gift message to the point of distribution.

9. The method of claim 1, wherein the plurality of art options further include one or more graphical designs which can be selected by the user to be included on the customized gift package.

10. The method of claim 9, wherein the graphical design can be customized with a photo or logo sent from a user.

11. The method of claim 1, further comprising:
offering a list of occasion options to a user; and
receiving a selected occasion option from a user;
wherein the plurality of customized gift package options offered to the user correspond to the selected occasion option.

12. A method for enabling a user to send a customized gift package to a recipient, receiving a selected shipping option comprising:
offering a plurality of customized gift package options to a user;
receiving a selected gift package option from a user;
offering a plurality of gift options to a user;
receiving a shipping destination from a user;
receiving a recipient's location from a user;
determining one or more shipping methods based the shipping destination and the selected gift option;
offering the determined shipping methods to a user;
receiving a selected shipping option from a user; and
transmitting information corresponding to the selected gift package option, the selected gift option, and the selected shipping option to at least one point of distribution for assembly and shipping of a customized gift package comprising the selected gift package option and the selected gift option;
wherein determining one or more shipping methods based on the shipping destination and the selected gift option comprises comparing a forecasted high temperature for the shipping destination with a plurality of shipping methods, wherein each shipping method comprises a recommended maximum temperature for shipping the selected gift option; and
and offering to the user a list of shipping methods in which the recommended maximum temperature is greater than or equal to the forecasted high temperature.

13. The method of claim 12, wherein determining one or more shipping methods comprises retrieving from a weather service current forecasted high temperature data corresponding to the shipping destination for a predetermined number of days.

14. A network-based method for providing a customized gift package to a recipient, comprising:
providing a web site having a user interface;
displaying through the user interface a plurality of customized gift package options;
receiving at the user interface a selected gift package option from a user;
displaying through the user interface a plurality of gift options;
receiving at the user interface a selected gift option from a user;
transmitting information corresponding to the selected gift package option and the selected gift option to at least one point of distribution for assembly and shipping of a customized gift package comprising the selected gift package option and the selected gift option;
wherein offering the plurality of customized gift package options includes offering a plurality of art options and further wherein the plurality of art options includes offering to receive a graphic file from a user.

15. A network-based method for providing a customized gift package to a recipient, comprising:
providing a web site having a user interface;
displaying through the user interface a plurality of customized gift package options;
receiving at the user interface a selected gift package option from a user;
displaying through the user interface a plurality of gift options;
receiving at the user interface a selected gift option from a user;
receiving at the user interface a shipping destination;
determining one or more shipping methods based on the shipping destination and the selected gift option;
displaying through the user interface one or more shipping methods;
receiving at the user interface a selected shipping option from a user; and
transmitting information corresponding to the selected gift package option, the selected gift option, and the selected shipping option to at least one point of distribution for assembly and shipping of a customized gift package comprising the selected gift package option and the selected gift option;
wherein determining one or more shipping methods based on the shipping destination and the selected gift option comprises comparing a forecasted high temperature for the shipping destination, a plurality of shipping methods, wherein each shipping method comprises a recommended maximum temperature for shipping the selected gift option and offering to the user a list of shipping methods in which the recommended maximum temperature is greater than or equal to the forecasted high temperature.

16. A computer-readable storage medium comprising executable code for instructing a computer to perform the method of claim 1.

17. A computer-readable storage medium comprising executable code for instructing a computer to perform the method of claim 12.

18. A computer data signal embodied in a carrier wave and representing sequences of instructions which, when executed by a processor, provide a customized gift package to a recipient, by performing the following:
offering a plurality of customized gift package options to a user;
receiving a selected gift package option from a user;
offering a plurality of gift options to a user;
receiving a selected gift option from a user; and
transmitting information corresponding to the selected gift package option and the selected gift option to at least one point of distribution for assembly and shipping of a customized gift package comprising the selected gift package option and the selected gift option;
wherein offering the plurality of customized gift package options includes offering a plurality of art options and further wherein the plurality of art options includes offering to receive a graphic file from a user.

19. A computer data signal embodied in a carrier wave and representing sequences of instructions which, when executed by a processor, provide a customized gift package to a recipient, by performing the following:
offering a plurality of customized gift package options to a user;
receiving a selected gift package option from a user;
offering a plurality of gift options to a user;
receiving a selected gift option from a user;
receiving a shipping destination;
determining one or more shipping methods based on the shipping destination and the selected gift option;
offering the determined shipping methods to a user;
receiving a selected shipping option from a user; and
transmitting information corresponding to the selected gift package option, the selected gift option, and the selected shipping option to at least one point of distribution for assembly and distribution of a customized gift package comprising the selected gift package option and the selected gift option;
wherein determining one or more shipping methods based on the shipping destination and the selected gift option comprises comparing a forecasted high temperature for the shipping destination with a plurality of shipping methods wherein each shipping method comprises a recommended maximum temperature and offering to the user a list of shipping methods in which the recommended maximum temperature is greater than or equal to the forecasted high temperature.

20. A system for enabling a user to send a customized gift package to a recipient, comprising:
a user interface;
an interaction module in communication with a processor and the user interface, wherein the interaction module comprises executable instructions for a processor to interact with a user through the user interface by:
offering a plurality of customized gift package options to a user, wherein the plurality of gift package options includes offering a plurality of art options, and further wherein the plurality of art options includes offering to receive a graphic file from a user;
receiving a selected gift package option from a user;
offering a plurality of gift options to a user; and
receiving a selected gift option from a user; and
a distribution module in communication with the processor and the interaction module, wherein the interaction module transmits information corresponding to the selected gift package option and selected gift option to the distribution module, and wherein the distribution module comprises executable instructions for assembly and shipping of a customized gift package.

21. A method for enabling a user to create a customized gift package for a recipient, comprising:
offering a plurality of customized gift package options to a user;
receiving a selected gift package option from a user;
offering a plurality of gift options to a user;
receiving a selected gift option from a user; and
transmitting information corresponding to the selected gift package option and the selected gift option to at least one point of distribution for assembly and distribution of a customized gift package comprising the selected gift package option and the selected gift option, wherein after the customized gift package is assembled the customized gift package is presented to the user for later delivery to a recipient;
wherein offering the plurality of customized gift package options includes offering a plurality of art options and further wherein the plurality of art options includes offering to receive a graphic file from a user.
